(19) United States
(12) Patent Application Publication
(10) Pub. No.: US 2014/0280516 A1
(43) Pub. Date: Sep. 18, 2014

(54) SYSTEM OF DYNAMIC INFORMATION RELAY USING GEOLOCATIONAL DATA

(71) Applicant: AUGMENT NATION, CHICAGO, IL (US)

(72) Inventors: Joseph Flowers, Chicago, IL (US); Joseph LEVY, Chicago, IL (US)

(73) Assignee: AUGMENT NATION, CHICAGO, IL (US)

(21) Appl. No.: 14/213,232

(22) Filed: Mar. 14, 2014

Related U.S. Application Data
(60) Provisional application No. 61/800,138, filed on Mar. 15, 2013.

(51) Int. Cl. G06F 17/30; H04L 29/08

(52) U.S. Cl. CPC G06F 17/30241; H04L 67/18
USPC 709/203

(57) ABSTRACT

A system and method for providing dynamic information relay by using geolocational data. Relay of information is triggered by proximity to the geolocation of objects of interest, thereby resulting in dynamic and automated information transmission to a mobile device.

### CROSS-REFERENCE TO RELATED APPLICATIONS

This application claims the benefit of priority to U.S. Provisional Patent Application No. 61/800,138 filed Mar. 15, 2013, which is herein incorporated by reference in its entirety.

### BACKGROUND

The invention generally relates to geolocational data retrieval and, specifically, to a system and method for providing a user interface for automatic passive and active retrieval of information proximate to a specific geolocation.

Global positioning systems (GPS) have become increasingly popular as personal devices have integrated the GPS technology. Personal consumer products such as cellular telephones, wireless personal data assistants (PDA), smart devices, automobiles, tablet computers, and laptop computers have all integrated GPS technology to the extent that GPS receivers are ubiquitous. GPS receivers only provide coordinates. Some in two-dimensions where longitudinal and latitudinal coordinates are provided. While newer GPS receivers now offer three-dimensional information where longitudinal, latitudinal, and altitudinal coordinates are provided. Because GPS receivers only provide coordinates, the GPS technology requires combination with maps or charts to fully utilize the geolocational data.

There have been various attempts to utilize this geolocational data. Currently tours have tried to utilize geolocational data provide by GPS receivers by constructing self-guided tours. In one type of tour a user is given a map coupled to a GPS receiver with points of interest and a timed audio recording. The user must travel to each point on the map and keep pace with the audio recording. The user must pause the recording, rewind the recording, rush to the next point, or fast-forward the recording if the user's pace is too fast. In other types of tours, the user starts the tour then must get to a next destination point and then re-start the tour by either manually restarting the tour by affirming that the user has arrived at the destination or scanning a QR code at the given destination.

### SUMMARY

Provided herein are systems and methods for dynamic relay of information by using geolocational data.

In one embodiment an information relay system for art includes a main server to process and deliver geolocational data and preference data from a first mobile device having a global positioning system receiver, wherein the mobile device includes a processor that automatically compiles preference data and geolocational data for transmission to the main server, a first database in communication with the main server having art information corresponding to geolocations, and a database schema to relate the received processed data to the art information corresponding to the geolocational data on the first database, wherein related art information corresponding to the geolocational data is compiled and transmitted to the first mobile device to be published and displayed on a map.

In another embodiment of the information relay system, the processor supports a user interface for preference data input and storage.

In another embodiment of the information relay system, the user interface includes access to social media resources.

In yet another embodiment of the information relay system, the user interface publishes notifications on the mobile device display when active.

In another embodiment of the information relay system, the user interface publishes notifications on the mobile device display when inactive.

In another embodiment of the information relay system, the mobile device includes a locked screen display.

In another embodiment of the information relay system, the user interface publishes notifications on the locked screen display.

In yet another embodiment of the information relay system, the published art information on the map is visible from the locked screen display.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 is a block diagram showing the data compilation and communication environment between the mobile device and the main database.

FIG. 2 illustrates a publication of an exportable schema.

FIG. 3 is general illustration of automatic geolocational data retrieval

FIG. 4 is an illustrated example of a public art tour in Push Notification Application Open (PNACH) mode.

FIG. 5 is a flow chart illustrating the process of setting user preference data.

FIG. 6 a flow chart depicting operation of the present invention wherein the user has set a preference to allow notification for pre-determined or “canned” tours.

FIG. 7 is a flow chart depicting operation of the present invention wherein the user has set a preference to display predetermined or canned tours within an expanded radius of 0.5 miles to over 2 miles from the user's location.

FIG. 8 is a flow chart illustrating a process by which a user may create a personal tour of objects of interest.

FIG. 9 is a flow chart illustrating the manner in which a personal tour may be modified.

FIG. 10 is a flow chart illustrating a process for automatic notification as the user brings the mobile device within the proximity range triggering the personal tours.

FIG. 11 is a user interface hierarchy illustrating user options to share their created personal tours via email or social media.

FIG. 12 is a block diagram showing the data compilation and communication environment between the mobile device and the main database as in FIG. 1, with the addition of a communication server and a second database.

FIG. 13 is a flow chart depicting the interface between the user in PNACH mode with the addition of image recognition to link to sponsor provided content.

FIG. 14 is a flow chart illustrating user interfacing with a QR code and application options presented to the user.

FIG. 15 illustrates an embodiment wherein after registration, a sponsor-provided push notification is triggered by pattern recognition.

### DETAILED DESCRIPTION OF THE INVENTION

Embodiments of the invention will now be described with reference to the Figures, wherein like numerals reflect like elements throughout. It is also to be understood that the terminology used in the description is for the purpose of describing the particular versions or embodiments only, and is not intended to limit the scope of the present invention which will be limited only by the appended claims. Although any methods and materials similar or equivalent to those described herein can be used in the practice or testing of embodiments of the present invention, the preferred methods and devices are now described. Furthermore, embodiments of the invention may include several novel features, no single one of which is solely responsible for its desirable attributes or which is essential for practicing the invention described herein. Nothing herein is to be construed as an admission that the invention is not entitled to antedate such disclosure by virtue of prior invention.

Unless defined otherwise, all technical terms used herein have the same meaning as commonly understood by one of ordinary skill in the art. It must also be noted that as used herein and in the appended claims, the singular forms “a,” “an,” and “the” include plural reference unless the context clearly dictates otherwise. Thus, for example, reference to a “main server” is a reference to one or more servers or computers.

Data Compilation and Communication Environment

FIG. 1 is block diagram showing, by way of example, the general communication environment of a first embodiment 10 of the invention. A mobile device 11 having a global positioning system (GPS) receiver 11a includes a processor 11c which automatically retrieves geolocational data 11b from the GPS receiver 11a and compiles the geolocational data 11b with the preference data 11d. The compiled data is automatically transmitted via the internet 14 to a main server 16 which processes the compiled data and delivers the compiled data to the first database 18, subject to the restraints within the preference data 11d. Within the first database 18 are exportable schemas 18a managed by the main server 16 and information of interest 18b, which is input or maintained by the owner of the first database 18. Depending on the preference data 11d, compiled data received by the main server 16 automatically generated and transmitted by the processor 11c, the main server 16 will export a schema 18a with information associated with the preference data 11d and geolocational data 11b to the mobile device 11 wherein the processor 11e will publish a notification on the mobile device 11 display. FIG. 2 illustrates and example publication of an exportable schema 18a on the display of mobile device 11. The publication may be a schema on the home screen display on the mobile device 11 or a publication as part of a map.

Geolocational data 11b may be generated by trilateration for planar coordinates or by 3-D trilateration to include altitudinal coordinates.

The information of interest 18b is entered or managed by the owner of the first database 18. In alternative embodiments, the end users may access and cause data to be into the first database 18. In these alternative embodiments, specific schemas 18a are exported to the mobile device 11 for the user to enter information of interest 18b in relation to the proximity of the user's geolocation. In yet another embodiment, the information of interest 18b may use software to incorporate meta search engine searches to populate the database with information of interest 18b found on the internet relating to specific geolocations. Information of interest 18b may include, without limitation, information pertaining to: public art, art in museums and other institutions, houses, buildings, bridges, architecture, geological landmarks, public transportation, houses, schools, restaurants, theatres, shops, bars, clubs, historical landmarks, and other similar objects or locations a user may take interest in knowing about features of potential interest within the user's local surroundings. The preference data 11b will dictate what information of interest 18b and ultimately what exportable schema 18a will be transmitted to the mobile device 11.

The mobile device 11 may have an internet connection via wi-fi or through a cellular phone service provider. The mobile device 11 in alternative embodiments may be a cellular phone, a smart phone, a tablet, a computer, a laptop computer, or the GPS receiver 11a by itself.

In other embodiments, the first database 18 and main server system 16 may be on-site and may not require an internet connection to for connectivity to receive schemas 18a and other data from the first database 18. In this alternative embodiment bluetooth, infrared, wi-fi, or radio signal may be sufficient.

Preference data may include, without limitation: the frequency at which the processor 11e will acquire geolocational data 11b from GPS receiver 11a; the proximity to an object that will trigger the processor 11e to send and received data to and from the main server 16; what types of objects will trigger the processor 11e to send and received data to and from the main server 16; permit use of the user's current location; names; types of events the user prefers to know about; audio notification options; what data the user prefers to receive; permit push notifications; and how the notifications will be displayed on the mobile phone. The preference data 11d is set to a default. However, a user, operating a user interface supported by the processor 11c, may modify the default preference data 11d.

In a preferred database compilation and communication environment as shown in FIG. 1, the first database 18 is a Mongo database from MongoDB Inc. (Palo Alto, Calif.) running a non-relational, “NoSQL”, database schema that is inherited by the main server 16 which is accessible to a user's mobile device 11. In this example, the Mongo database includes an object data table, an artist data table, and a tour data table.

The object table includes data on the types of objects, the identification tags of all objects, names of the objects, the geolocations of the objects, tours associated with the objects, the artists associated with the objects.

The artist table includes all the object data and includes informational data such as text biographies, audio files on the artist, and video files on the artist. The tour table includes all the names of the tours, the tours, and identification tags of all objects in each tour.

In this example, the object table is passively accessed by the mobile device, meaning that the application will automatically query the object table.

The user interface may be a GOOGLE maps application program interface (API), a YAHOO! maps API, or other similar APIs. In other embodiments the user interface may not be the GOOGLE maps API or similar API but merely include such APIs.

The user interface is not limited to preference data 11d input and may include social media options to share user preferences, location history, and location recommendations. Social media options may include FACEBOOK, FOURSQUARE, TWITTER, INSTAGRAM and FLICKR, or other similar social media sites and resources.

The user interface may also be used to plan tours or choose to execute pre-made tours triggered by automatically sent geolocational data 11b once the user is in the proximity of specific geolocations.

The user interface may also include, without limitation: games; instant messaging services; email services; live streaming; local home price listings; driving guide map services;

walking guide map services; local restaurant listings; access to local restaurant ratings; local theatre listings; local gas station listings; local event listings; local school listings; local school ratings; advisory notices; local train stop locations; local public transport access points; and other similar items that a user may take interest to know in the user's local surroundings.

The user interface may generate push notification while the user interface is open or closed. In one embodiment the user interface is a mobile device application or “app.” While the app is closed, a push notification may be generated by the app and displayed on the mobile device display, this mode of push notification application closed is referred to hereinafter as “PNAC”. The push notification may give options of accessing data transmitted by the main server 16 or ignoring the transmitted data. If the user opts to access the data, the data is displayed on the mobile device. The notification may be displayed on the mobile device lock screen display. While the app is open a push notification may be still generated in PNACH mode, which allows the user to choose to accept and display data transmitted by the main server 16. In some embodiments the preference data 11d may allow automatic display of data transmitted by the main server 16 whether in PNAC and/or in PNACH mode.

In an alternative embodiment, the user will manually instruct the processor 11c to retrieve geolocational data 11b for compilation with preference data 11d for transmission to the main server 16 to receive information of interest.

In an alternative embodiment, the mobile phone 11 display may be in a locked screen mode commonly implemented on mobile phones to prevent inadvertent dialing and passcode protection. While in the locked screen mode, the visual exported schema 18a can be displayed.

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof

Geolocational Data Retrieval

FIG. 3 is a general illustration of automatic geolocational data 11b retrieval event 30. The proximity range 34 is part of the preference data 11d. Breach of a proximity range 34 is determined by frequent calculation by the processor 11c (not shown) of the coordinates of objects of interest 32 and geolocational data 11b transmitted by the GPS satellite 36 to the GPS receiver 11a (not shown). On the event that the mobile device 11 breaches the proximity range 34 of an object of interest 32 the processor 11e (not shown) of the mobile device 11 will transmit compiled the geolocational data 11b and preference data 11d via the internet 14 to the main server 16 (not shown).

The proximity range 34 may be modified by the user and may range from about 25 feet to about 2 miles. The preferred range is from about 50 feet to about 0.25 mile.

Geolocational data 11b may be retrieved automatically or the user may manually transmit geolocational 11b.

In a preferred manually requested and passive information relay based on geolocation, the example embodiment is an Android operating system based application that employs a location listener to continuously receive updated geolocational data 11b upon movement of the mobile device 11 determined by GPS, Cell-ID, or Wi-FI and reviews the list of objects stored in the preference data 11d associated with the geolocational data 11b of the mobile device 11. If the objects associated with the geolocation are found, the application will populate a scrollable list with object names. The application will also send a HTTP (hypertext transfer protocol) request to the main server 16 where a PHP (hypertext preprocessor) on the main server 16 will perform a query of the object table and send a schema 18a in the form of results encapsulated in a JSON (JavaScript Object Notation) object to the mobile device 11. In this particular example, the Mongo database has a concept called a 2d index or geo-hash, that can query for objects at the location within a user determined radius. The radius may also be dynamically determined by the user such as by pinch-zooming on a displayed map. Furthermore, the request can be sent by other transfer protocols such as Amazon's dynamo DB, couch-based DB, and other such transfer protocols.

The application extracts the JSON encapsulated results and adds any new objects and corresponding geolocation data to the preference data 11d such that the preference data 11d continuously grows. Schema 18a may also be in the form of results encapsulated in XML, CSV, Excel, TXT, and other such formats.

Thus, as the mobile device 11 moves, the location listener receives location updates which are then resolved using an Android Location library. The application then compares the geolocation coordinates of the mobile device to objects and their geolocations. When the mobile device comes into the proximity of the longitude and latitude associated with an object tag stored in the preference data or received from the main server, the application will display the populated scrollable list if the application is open. If the application is running in the background or the mobile device is in an energy saving mode, a push notification alert will be displayed allowing the user to access the scrollable list.

### EXAMPLES AND ILLUSTRATIONS

These detailed examples serve to exemplify the above embodiments which form part of the invention. These detailed descriptions are presented for illustrative purposes only and are not intended as a restriction on the scope of the invention. To simplify the explanation the examples are directed towards an information relay system in the form of an Android operating system based application.

FIG. 4 is a flow chart that illustrates the sequence of choices and example schemas 18a presented to the user once the notification is accepted. Once the user sets preference data 11d to allow push notifications while the app is on (PNACH), search for object tours 41b, and specifically search for canned (pre-made) tours 41c, the user will receive a notification icon 41d. In this example, the user slides the icon and is presented with a screen 42. The screen 42 is an exported schema 18b, which includes a data entry field search box 44, interest tiles 46, a picture 48 of the object of interest 32, an informational voice recording 43 about the object of interest 32 and an advertisement box 49. The user is offered the option to take canned tour A. If the user opts to take the tour, the screen will transition to an enlarged tour map 45 and the user will follow a preset route. As the user nears an object of interest 32 (not shown) and breaches the proximity range 34 a notification will pop up on the map as shown in FIG. 2 at which time the user may click on the pop up to enlarge the pop up and choose among the options given in the enlarged pop up. On some mobile devices the pop up may be of sufficient size where enlargement is unnecessary and the options will be clickable without enlargement.

In one exemplary embodiment as shown in FIG. 2, is an Android operating system based application having an enlarged pop up with options that include a button for pictures, an audio clip, and a movie clip. If the user taps on the picture a device size adjusted image will be downloaded from an Amazon S3 server. The application in this particular embodiment uses an Amazon AWS (Amazon Web Services) SDK (Source Development Kit) in order to do the querying and downloading of these images. The downloaded images may be shown as a slideable gallery. If the audio clip button is selected, the application will stream an existing audio file using Android's MediaPlayer library. The audio files are hosted on the Amazon S3 server. The audio files hosted on the Amazon S3 server include audio files about the artist and audio files about the object. If the movie clip button is selected, the application will stream an existing video using Android's MediaPlayer library. The video may be hosted on the Amazon S3 server as well with querying performed by Amazon AWS. The videos hosted on the Amazon S3 server include videos about the artist and videos about the object. The user will be prompted with a full-screen window for a full view experience.

Other options as shown in FIG. 2 include directions to the object which will provide directions for walking, biking, bus, train, and driving to the object. The directions will be provide by a third source such as MapQuest using OpenStreetMap data. In this particular example, the application will use the MapQuestRoadManager library in order to provide routing directions to the user.

The user may also add the object to a personal tour via the Add to Personal Tour option as shown in FIG. 2. In this way the user may string together individual objects in a self-made tour.

FIG. 5 illustrates a user setting preference data 11d that may trigger a tour as shown in FIG. 4 and FIG. 6. In FIG. 5 the user sets the preference data 11d to retrieve information of interest 18b relating to objects. Once the user selects an object, the user can save the selection and create a list of objects that the processor 11c will compile to send to the main server 16. The illustration further shows that a more specific preference wherein relative searches on selected objects such as sculptures and paintings may be further narrowed to a specific artist or to specific artists. If the selected artist was Picasso and the list of objects included sculptures a tour such as the one shown in FIG. 4 may be transmitted by the main server 16 to the mobile device 11.

FIG. 6 depicts an example wherein the user has set a preference to allow notification for canned tours relating objects within a 0.25 mile range. In this example the user has chosen canned tour A. During the tour, as the user walks within the proximity range 34 of specific objects, such as object A2 or A5, a pop up as seen in FIG. 2 may appear on the map containing information relevant to that object. The information relevant to that object may also include other canned and personal tours that are associated with that object which overlap the current tour, giving the user the option to embark on a different tour.

FIG. 7 is a flow chart representing a range preference expanded from 0.25 miles to 0.5 miles. In this flow chart, a user receives an automatic notification for offers on additional canned tours E through G according to the user's modified preference data 11d. In this example, the user has set a preference to allow notification for canned tours of a particular list of objects within a 0.5 mile range. The user can expand the range preference that would introduce more canned tours. The user may also change, add, or delete other preferences such as search objects or artists at any time to broaden, narrow, or change the search results. In this example the user has chosen canned tour E. During the tour, as the user walks within the proximity range 34 of specific objects, such as object E6 or E5, a pop up as seen in FIG. 2 may appear on the map. In this example, walking to the edge of canned tour E puts the user in proximity of canned tour G and personal tour 1.

FIG. 8 illustrates how a user can create a personal tour based on location instead of relying on pre-made canned tours. In FIG. 8 the user inputs a specific location and the proximity range 34 to trigger the event. The user then selects specific objects to see on the tour. If the list of objects is saved, the list is transmitted to the main server 16 and stored in the first database 18 with a tagged with the mobile device tag and/or a user defining meta-tag to allow access only by the mobile device that created the tour or the user that created the tour.

FIG. 9 illustrates that the personal tour may be modified through the use of the user interface or app. The user can select any of the personal tours created and add or delete preference data 11d.

FIG. 10 is a flow chart representing automatic notification as the user brings the mobile device 11 within the proximity range 34 triggering the personal tours. In this example the user has chosen personal tour A. During the tour, as the user walks within the proximity range 34 of specific objects, such as object A2 or A5, a pop up as seen in FIG. 2 may appear on the map containing information relevant to that object. The information relevant to that object may also include other canned and personal tours that are associated with that object which overlap the current tour, giving the user the option to embark on a different tour.

In another embodiment not shown. The geolocation data 11b may be created by three-dimensional (3-D) trilateration enabling the processor 11c to compile and send altitudinal data to the main server 16. In this embodiment entry of 3-D coordinates into the first database 18 would enable the creation of canned tours, personal tours, and information pop-ups within a building. More specifically, one embodiment would enable a user to walk into a museum and automatically receive notifications for tours and pop-ups of information once the user brings the mobile phone within range of a piece of art. In other embodiments the information received could instruct a user where to look and what the user is viewing, at certain elevations. For example, if looking out the east side of the Willis Tower Skydeck, an automatic notification may be sent to the user's mobile device. If opened, information published on the mobile phone display would instruct the user that the large body of water is Lake Michigan. Or if the preference data is set to allow information to be published on the locked screen display an audible notification would direct the attention to the automatically published information on the locked screen display comprising similar information.

FIG. 11 shows that the user may share their created personal tours and objects. In this embodiment the user interface or app may provide sharing via third party apps such as facebook, twitter, foursquare, and other similar apps. The user may set a preference for posting to each selected medium. In this embodiment photos, videos, tour maps, email, and text messaging (SMS) is supported by the third party apps. FIG. 11 also presents the ability for the social community to rank. This ranking system can extend not only to personal created tours and canned tours but to ranking all objects contained on the main server 16.

In another embodiment as shown in FIG. 12 a second database 124 and a communication server 122 provide a social network for users of the specific user interface or app used to create and run tours. FIG. 12 is only one example used to illustrate that the invention may be capable of hosting a social network. The communication environment shown in FIG. 1 may also be capable of supporting a social network. In other embodiments the communication server 122 may not be in communication with the main server 16. Instead the user interface or app may instruct the processor 11c to route certain data through the internet 14 directly to the communication server 122. In other embodiments there may be a communication server 122, a main server 16, a first database 18, and no second database 124. The first database 18 may be sufficient for supporting a social network. In other embodiments there may be multiple servers and multiple databases. One of ordinary skill in the art is necessarily familiar with alternative setups and environments that can enable a social network of users.

The social network embodiment may offer tour sharing, picture sharing, tour ranking, blogs, comments, instant messaging, email, and offer users the opportunity to make groups. More specifically the social networking group creation experience will allow users to make tour groups and find each other by mobile device GPS location. One embodiment would allow group members to join a group, wherein one of the preference data elements is that a certain number of group members must be within proximate range for the tour to initiate. Another embodiment would notify a user if another user is near and present an opportunity to merge the current tours so that the users could enjoy the tour experience together. In another embodiment, a first user may set the preference data 11d to send a notification as soon as a second user's mobile device 11 breaches a proximity range 34 set by the first user around his or her own current geolocation. For example, a first user may be sitting in a restaurant waiting for a second user. The first user may set the preference data to notify him or her once the second user's mobile phone come within a 0.1 mile proximity range.

In another embodiment a first user may set the preference data 11d to send a notification as soon as a second user's mobile device 11 breaches a proximity range 34 set by the first user at a specific geolocation. For example, a first user may drop off a second user at the airport. The first user may set the preference data to notify him or her once the second user's mobile is within 0.25 miles of the geolocation defining the destination airport and another notification when the second user gets within 500 feet of the geolocation defining the second user's home.

FIG. 13 provides a depiction of sponsor push notifications when the application is open (SPNACH). In one embodiment, the user clicks on an advertisement while on a tour such as advertisement 49 in FIG. 4. This will initiate sponsor-provided content such as videos for entertainment or information purposes, games, or promotional coupons. In another embodiment, in the event the mobile device 11 comes within a geolocation such as a store while on a tour and a notification will appear which, if activated, will switch on the camera functions of the mobile device 11. The user then scans QR codes, patterns, logos, or other types of in-store signage, which would trigger sponsor-provided content to be transmitted to the user's mobile device 11. The sponsor-provided content the user views or accesses may also be shared on third party social networking applications as designated by the user.

FIG. 14 contemplates embodiments wherein the user may scan a QR code leading to the downloading of the tour app. Registration as a member would include a sponsor premium. Once on tour, sponsor push notifications triggered by proximity to certain objects on tour would take priority.

FIG. 15 illustrates an embodiment wherein after registration, a sponsor-provided push notification is triggered by pattern recognition. For example, if the user takes a picture of a painting that the first database 18 recognizes as a Picasso, a canned or personal tour may be initiated and activate a sponsor promotional advertisement.

In another embodiment not shown, preference data 11b may be set to extract information of interest 18b pertaining to houses. In this embodiment the user may set preference data 11b to allow notification and display of house prices on the users mobile device 11. For example, as the user's mobile phone comes within the proximity range 34 of a house, the most recent reported price of the house may be automatically displayed on the user's mobile device 11. In another example, the house price and/or the history of the house may be displayed which include appliances installed in the house, maintenance, renovation, or damage.

In another embodiment not shown, the invention may serve as a medium for public service announcements. In one example, the preference data 11d may be set to automatically receive push notifications from a school providing that the mobile device is within a specified range of a school district or other geolocation such as the user's home. Announcements may be sent for school delays, cancellations, or emergencies to the mobile devices.

In another embodiment not shown, the invention may serve as a parade concierge. In one example of this embodiment, each parade float will have a GPS device. Therefore, in this example the proximity range 34 of the float is not breached by the mobile device 11 moving closer to the object, but by the object moving closer to the mobile device 11. When the proximity range 34 is breached a pop-up as shown in FIG. 2 may appear with information on the float and additional options such as pictures, audio clips, and movie clips. An option not shown in FIG. 2 for this embodiment may be an option to rank the float as it passes by to be shared with a social network community as described in FIG. 11 and FIG. 12. In another example, the pop up as shown in FIG. 2 will appear as a function of timing and not by a breach of the proximity range 34. Since parade routes have predefined times as based on a set schedule and predefined distance based on the scheduled route, the route can be divided into discrete segments. For example, if a four mile route is segmented into eight half mile sectors and the parade is scheduled to last one hour, each float will spend about 7.5 minutes in each sector. Based on the geolocation of the mobile device which will be within a specific sector along the parade route, the pop-up as shown in FIG. 2 may be timed to pop-up when a float is calculated to enter that specific sector.

In yet another embodiment also not shown, the mobile device 11 may serve as a triggering mechanism for safety clothing. The safety clothing in the embodiment includes a light and/or sound source connected to a power source which is controlled by a receiver. As the mobile device breaches the proximity range 34 of an object such as a traffic light, an intersection, traffic sign, or any other geolocation where there is possible traffic, the mobile device 11 will send a Bluetooth signal to the receiver. The receiver will then activate the power source to turn on lights and/or activate a sound source to alert drivers and other bystanders that the user is present at the intersection.

In another embodiment not shown, advertisement push notifications may be displayed on the mobile device when in the proximity of a sporting event. For example, a user's mobile phone entering a football stadium triggers sponsor-provided content to be transmitted to the user's mobile device 11. The sponsor-provided content can be transmitted and displayed on the mobile device 11 in the PNACH or SPNACH mode. While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. An information relay system comprising:
a main server to process and deliver geolocational data and preference data from a first mobile device having a global positioning system receiver, wherein the mobile device includes a processor that automatically compiles preference data and geolocational data for transmission to the main server;
a first database in communication with the main server having information corresponding to geolocations of public artworks; and
a database schema to relate the received processed data to the public artworks information corresponding to the geolocational data on the first database,
wherein other information relating to the geolocated public artwork is transmitted to the first mobile device to be published and displayed on a user device.

2. The information relay system of claim 1, wherein the processor supports a user interface for preference data input and storage.

3. The information relay system of claim 2, wherein the user interface includes access to social media resources.

4. The information relay system of claim 2, wherein the user interface publishes notifications on the mobile device display when active.

5. The information relay system of claim 2, wherein the user interface publishes notifications on the mobile device display when inactive.

6. The information relay system of claim 2, wherein the mobile device includes a locked screen display.

7. The information relay system of claim 6, wherein the user interface publishes notifications on the locked screen display.

8. The information relay system of claim 6, wherein the published art information on the map is visible from the locked screen display.

9. An information relay system comprising:
a main server to process and deliver geolocational data and preference data from a first mobile device having a global positioning system receiver, wherein the mobile device includes a processor that automatically compiles preference data and geolocational data for display on the first mobile device and transmission to the main server;
a first database in communication with the main server having information corresponding to a geolocation of an object; and
a database schema to relate the received processed data to the object information corresponding to the geolocational data on the first database,
wherein other information relating to the object is transmitted to the first mobile device to be published and displayed on a user device.

10. The information relay system of claim 9, wherein the processor supports a user interface for preference data input and storage.

11. The information relay system of claim 10, wherein the user interface includes access to social media resources.

12. The information relay system of claim 11, wherein the social media resource is supported by internal servers and databases.

13. The information relay system of claim 10, wherein the user interface publishes notifications on the mobile device display when active.

14. The information relay system of claim 10, wherein the user interface publishes notifications on the mobile device display when inactive.

15. The information relay system of claim 10, wherein the mobile device includes a locked screen display.

16. The information relay system of claim 15, wherein the user interface publishes notifications on the locked screen display.

17. The information relay system of claim 15, wherein the published object information on the map is visible from the locked screen display.

18. The information relay system of claim 9, wherein the object is public artwork.

19. The information relay system of claim 9, wherein the object is a parade float.

20. The information relay system of claim 9, wherein the first database is a non-relational database.
